(19) United States
(12) Patent Application Publication
(10) Pub. No.: US 2014/0305507 A1
(43) Pub. Date: Oct. 16, 2014

(54) SELF-ORGANIZING MULTI-STREAM FLOW DELIVERY PROCESS AND ENABLING ACTUATION AND CONTROL

(71) Applicant: General Cybernation Group, Inc., Rancho Cordova, CA (US)

(72) Inventors: George Shu-Xing Cheng, Folsom, CA (US); Steven L. Mulkey, Cameron Park, CA (US); Qiang Wang, Sacramento, CA (US)

(73) Assignee: General Cybernation Group, Inc., Rancho Cordova, CA (US)

(21) Appl. No.: 14/169,074

(22) Filed: Jan. 30, 2014

Related U.S. Application Data
(60) Provisional application No. 61/812,171, filed on Apr. 15, 2013.

(51) Int. Cl. G05D 7/06

(52) U.S. Cl. CPC G05D 7/0617
USPC 137/10; 137/565.16

(57) ABSTRACT

A Self-Organizing Multi-Stream Flow Delivery Process and Enabling Actuation and Control are introduced. The method and apparatus of building a general-purpose self-organizing multi-stream flow delivery process are presented. As a case example, an actuation and control system to control a multi-stream liquid flow delivery process using Self-Organizing Actuation and Control Units (SOACU) is described.

### INVENTION

This application claims priority to U.S. Provisional Application No. 61/812,171 filed on Apr. 15, 2013, which is herein incorporated by reference.

The subject of this patent relates to physical processes and their actuation and control systems including industrial processes, equipment, facilities, buildings, devices, boilers, valve positioners, motion stages, drives, motors, turbines, compressors, engines, robotics, vehicles, and appliances.

In the U.S. patent application No. 61/727,045, the entirety of which is hereby incorporated by reference, we described a Self-Organizing Process Control Architecture that comprises a Sensing Layer, Control Layer, Actuation Layer, Process Layer, as well as Self-Organizing Sensors (SOS) and Self-Organizing Actuators (SOA). A Self-Organizing Sensor with an artificial neural network (ANN) based dynamic modeling mechanism to measure a CFB Boiler Bed Height is presented. A method to develop a Self-Organizing Sensor that has one or multiple input variables is disclosed.

In the U.S. patent application No. 61/812,143 entitled Method and Apparatus of Self-Organizing Actuation and Control, the entirety of which is hereby incorporated by reference, we described a Self-Organizing Control Architecture that comprises a Sensing Layer, Control Layer, Actuation Layer, Process Layer, as well as Self-Organizing Sensors (SOS), Self-Organizing Actuators (SOA), and Self-Organizing Actuation and Control Units (SOACU). The method and apparatus of SOA and SOACU in process control are presented. A control system as a case example for a gas mixing process is described using the unique SOA and SOACU approaches.

This invention was made with government support under SBIR grant DE-SC0008235 and SBIR grant DE-FG02-08ER84944 awarded by the U.S. Department of Energy. The government has certain rights to the invention/

During the development of the Self-Organizing methods for sensing, actuation, and control, new ideas naturally occurred. Are self-organizing methods only applicable to sensors, controllers, and actuators? Can Self-Organizing concepts and approaches be applied to other areas? This led to the following invention.

In this patent, we introduce a self-organizing multi-stream flow delivery process and the enabling actuation and control system. The method and apparatus of building a general-purpose self-organizing multi-stream flow delivery process are presented. As a case example, an actuation and control system to control a multi-stream liquid flow delivery process using Self-Organizing Actuation and Control Units (SOACU) is described. The flow delivery process comprises a number of flow streams, each of which is regulated by a flow valve. A pressure valve is added onto the main flow line to “choke” the pressure to allow the flow control valves to work in their relatively linear ranges so that they can regulate the flows adequately. This design can also reduce or even eliminate the need of using valve positioners for the flow valves resulting in cost savings.

In the accompanying drawings:

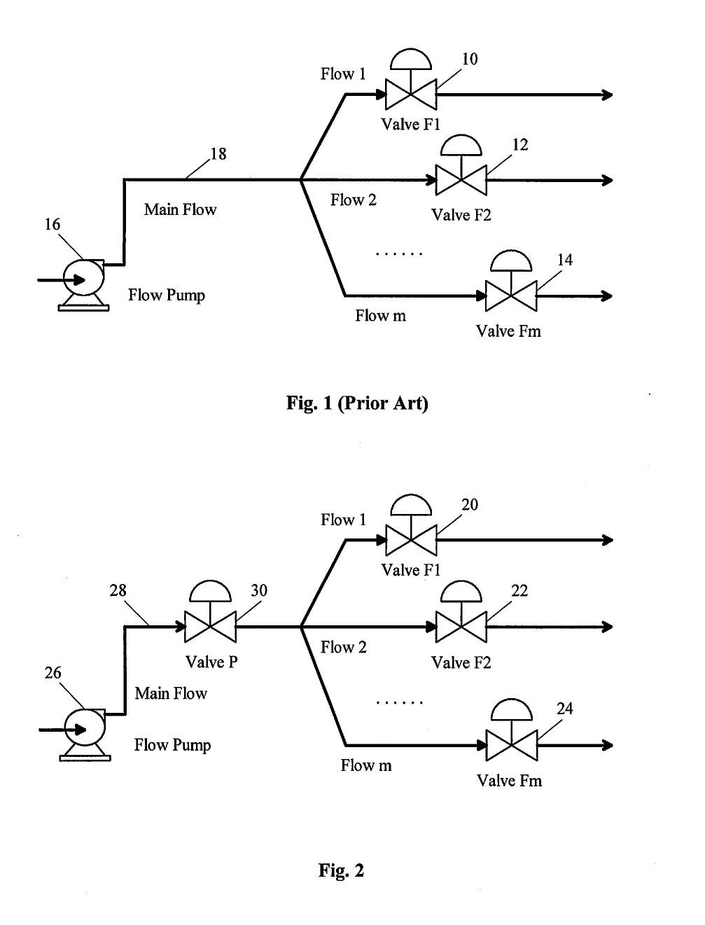

FIG. 1 is a process and instrument diagram illustrating a traditional multi-stream liquid flow delivery process comprising a flow pump and multiple flow valves.

FIG. 2 is a process and instrument diagram illustrating a self-organizing multi-stream liquid flow delivery process comprising a flow pump, multiple flow valves, and a pressure valve on the main flow stream according to an embodiment of this invention.

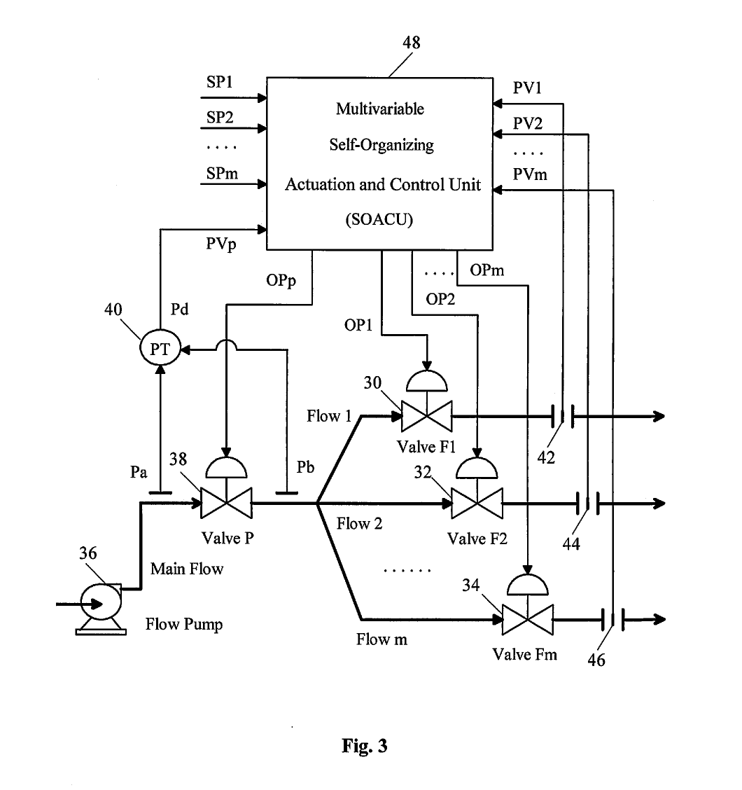

FIG. 3 is a process and instrument diagram illustrating a multi-stream flow delivery process control system comprising a Multivariable Self-Organizing Actuation and Control Unit (SOACU) according to an embodiment of this invention.

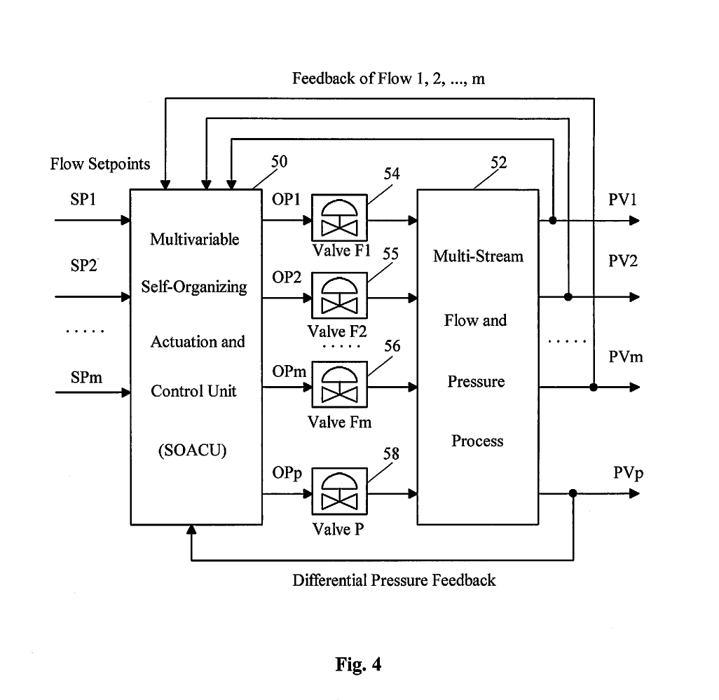

FIG. 4 is a block diagram illustrating a multi-stream flow delivery process control system comprising a Multivariable Self-Organizing Actuation and Control Unit (SOACU) according to an embodiment of this invention.

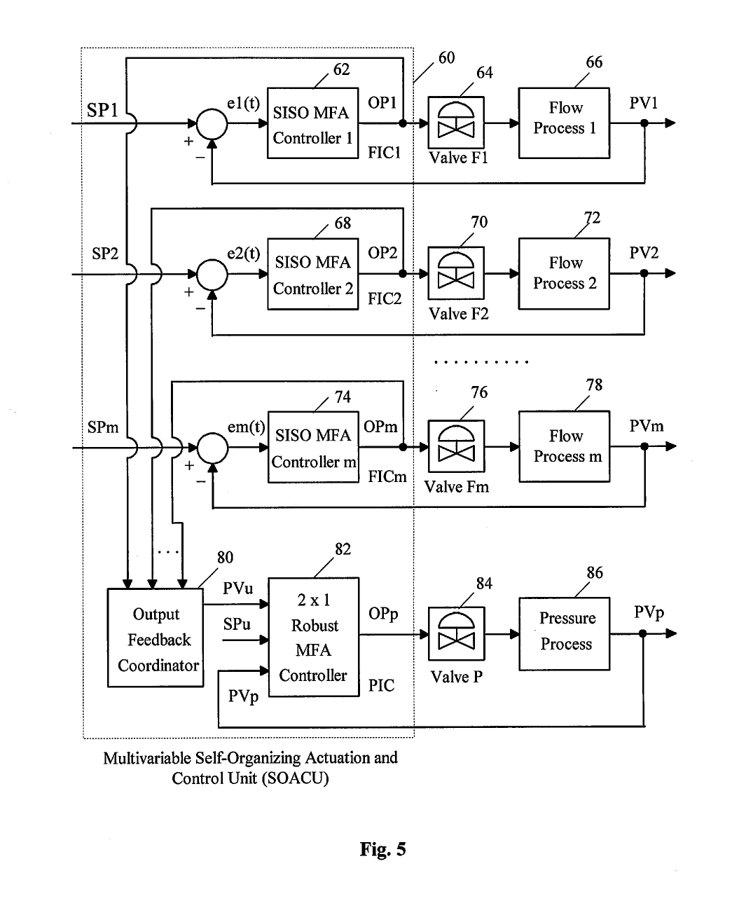

FIG. 5 is a block diagram illustrating a multi-stream flow delivery process control system comprising multiple single-loop flow control sub-systems and a pressure control sub-system using Model-Free Adaptive (MFA) controllers to show the composition of a Multivariable Self-Organizing Actuation and Control Unit (SOACU) according to an embodiment of this invention.

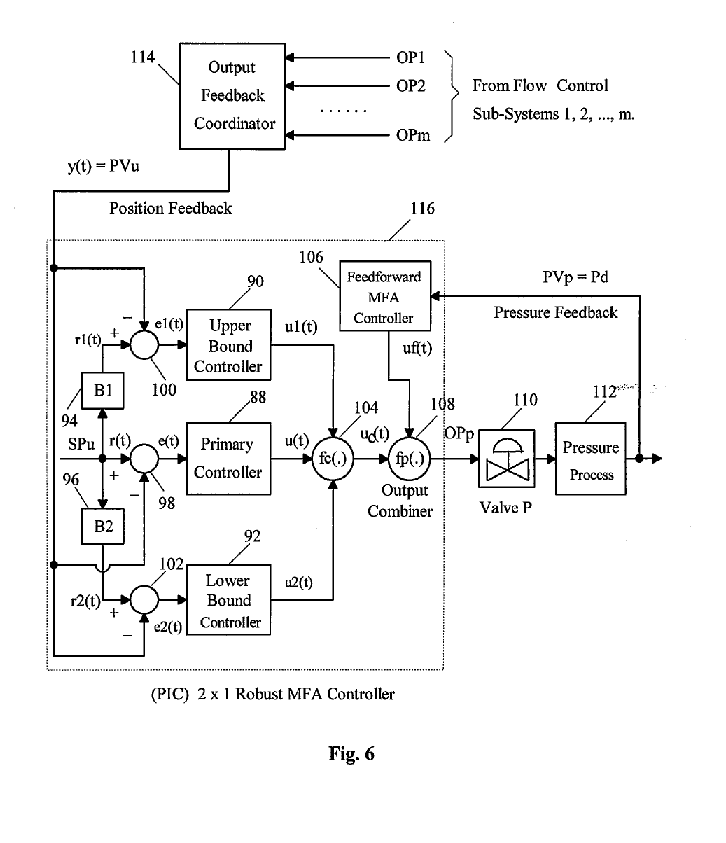

FIG. 6 is a block diagram illustrating the detailed design of a 2×1 Robust MFA Controller and an Output Feedback Coordinator as part of the Self-Organizing Actuation and Control Unit (SOACU) in FIG. 5 according to an embodiment of this invention.

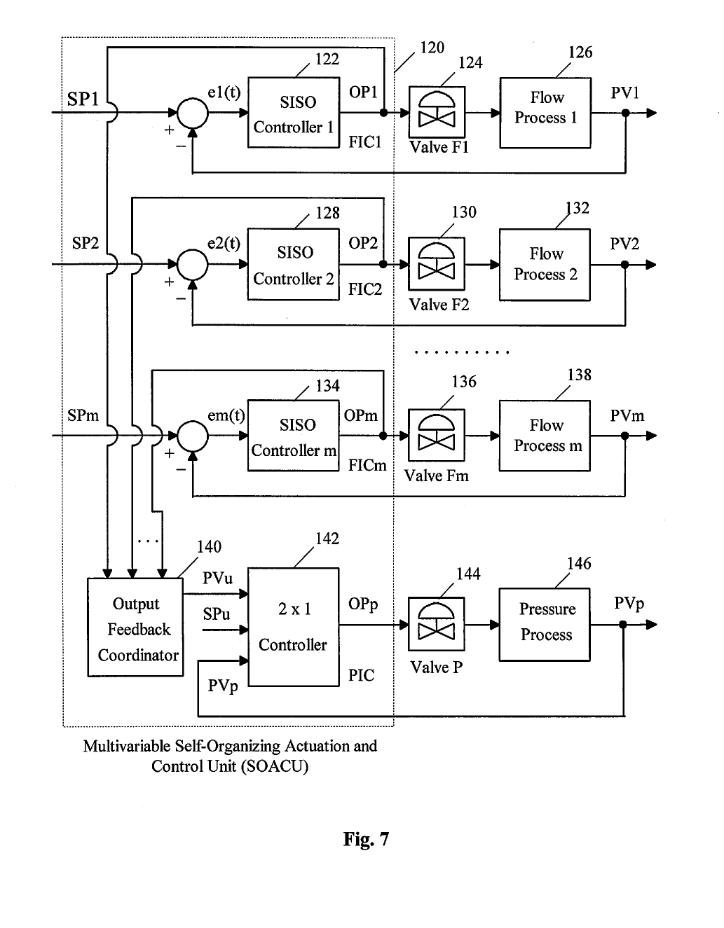

FIG. 7 is a block diagram illustrating a multi-stream flow delivery process control system comprising multiple single-loop flow control sub-systems and a pressure control sub-system using traditional controllers such as PID controllers to show the composition of a Multivariable Self-Organizing Actuation and Control Unit (SOACU) according to an embodiment of this invention.

In this patent, the term “mechanism” is used to represent hardware, software, or any combination thereof. The term “process” is used to represent a physical system or process with inputs and outputs that have dynamic relationships. The term “sensor” is used to represent a sensing mechanism. The term “actuator” is used to represent an actuation mechanism or an actuation device in a control system. The term “control loop” refers to a single-loop feedback control system. The term “SISO” refers to Single-Input-Single-Output. The term “2×1” refers to “2-Input-1-Output”. The term “MFA” refers to Model-Free Adaptive control or controllers.

Throughout this document, m=1, 2, 3, . . . , as an integer, which is used to indicate the number of flows in a multi-stream flow delivery process.

A method or apparatus is used to control a fluid, i.e., gas or liquid flow process. Throughout this document, if a method or apparatus is used to control a gas flow process, it may also be applied to a liquid flow process without departing from the spirit or scope of the invention. If a method or apparatus is used to control a liquid flow process, it may also be applied to a gas flow process without departing from the spirit or scope of the invention.

Without losing generality, all numerical values given in this patent are examples. Other values can be used without departing from the spirit or scope of the invention. The description of specific embodiments herein is for demonstration purposes and in no way limits the scope of this disclosure to exclude other non-specifically described embodiments of this invention.

### DESCRIPTION

We will first review the concept of Distributed Intelligence, Self-Organizing, and other related terms in preparation for the discussion of the invention.

### Distributed Intelligence

Distributed Intelligence can be considered an artificial intelligence method that includes distributed solutions for solving complex problems. It is closely related to Multi-Agent Systems.

### Self-Organizing

Without using strict and academic type definitions, Self-Organizing can be understood as an organization that is achieved in a way that is parallel and distributed. Here, parallel means that all the elements act at the same time, and distributed means no element is a central coordinator.

### Self-Organizing System

A self-organizing system is a complex system made up of small and simple units connected to each other and having self-organizing capabilities.

### A. Self-Organizing Process

A Self-Organizing Process can be defined as a physical system or process with inputs and outputs that have dynamic relationships, where certain key elements are arranged to act in a coordinated way at the same time to achieve certain objectives.

A Self-Organizing Process can have one or more of the following properties:

1. Key elements of the process are organized so that they act in a coordinated way at the same time;

2. If a traditional process does not have sufficient elements to be self-organized, key elements need to be added to become a Self-Organizing Process;

3. Information among the key process elements is shared and utilized to achieve certain objectives;

4. A Self-Organizing Process provides the foundation to implement Self-Organizing Sensing (SOS), Self-Organizing Actuation (SOA), and/or Self-Organizing Actuation and Control Units (SOACU); and

5. A Self-Organizing Process requires Self-Organizing Sensing (SOS), Self-Organizing Actuation (SOA), and/or Self-Organizing Actuation and Control Units (SOACU) to enable its self-organizing capabilities.

Potential key differences, one or more of which may exist between the traditional process architecture and the Self-Organizing Process Architecture, are compared and summarized in Table 1.

TABLE 1

| | | Traditional Process | Self-Organizing Process |
|---|---|---|---|
| No. | Common Property | Architecture | Architecture |
| 1 | There are multiple | Elements do not act | Certain key elements |
| | elements. | in a coordinated way. | act in a coordinated |
| | | | way at the same time. |
| 2 | N/A | May lack certain key | Self-organizing enabling |
| | | elements. | elements are included. |
| 3 | Information is | Information among key | Information among key |
| | available. | elements is not shared | elements is shared on a |
| | | on a regular basis. | regular basis. |
| 4 | N/A | May not have the | Has the foundation to |
| | | foundation to | implement SOS, SOA, |
| | | implement SOS, SOA, | and/or SOACU. |
| | | and/or SOACU. | |
| 5 | N/A | N/A | Requires SOS, SOA, and/or |
| | | | SOACU to enable its self- |
| | | | organizing capabilities. |

### B. Multi-Stream Flow Delivery Process Control

To see the differences between a traditional process and a Self-Organizing Process, we use a multi-stream liquid flow delivery process as a case example.

FIG. 1 is a process and instrument diagram illustrating a traditional multi-stream liquid flow delivery process comprising a flow pump and multiple flow valves. The process comprises a flow pump 16 that pumps liquid through the main flow line 18, which is split into m flow streams Flow 1, Flow 2, . . ., Flow m. In order to control the flow streams, m flow valves are used, including Valve F1 10, Valve F2 12, and Valve Fm 14.

From a material balance point of view, a multi-stream flow delivery process is often a challenging process to control. If the main flow stream lacks material due to a sudden change in demand, the pressures on each flow stream will drop forcing the flow valves to be wide open. In this case, the flow valves work in their nonlinear range and the flow controllers may not be able to maintain consistent control. On the other hand, if the flow pump delivers too much material causing a higher pressure on the flow streams, the flow valves will work in their lower operating range. Then, the flow controllers may also have a difficult time to control the flows. This is a good case example where not only the traditional controllers and actuators may not work well, but the process itself has fundamental weaknesses.

FIG. 2 is a process and instrument diagram illustrating a self-organizing multi-stream liquid flow delivery process comprising a flow pump, multiple flow valves, and a pressure valve on the main flow stream according to an embodiment of this invention. The process comprises a flow pump 26 that pumps liquid through the main flow line 28, which is split into m flow streams Flow 1, Flow 2, . . . , Flow m. To control the flows, m flow valves are used, including Valve F1 20, Valve F2 22, and Valve Fm 24.

In a Self-Organizing Multi-Stream Flow Delivery Process, a pressure valve 30 is added to regulate the main flow line so that the flow pump can be set to deliver a sufficient amount of material to meet the sudden demand changes. In the mean time, the pressure valve 30 can regulate the pressure allowing the flow valves to work in their relatively linear range. This way, valve positioners for all the flow valves may not be needed resulting in cost savings.

The objective is to control the multi-stream flows under varying operating conditions. The pressure controller 30 is required to keep the differential pressure Pd stable so that the flows can be effectively controlled. It is important to know that this multi-stream flow delivery process cannot be effectively controlled using traditional process control methods. Mainly, the pressure valve 30 is trying to regulate the pressure of the main flow that distributes flows to multiple flow streams. The pressure valve and multiple flow valves are side-by-side trying to control the same flows. When a pressure controller is used to control the pressure, it affects the flows. When the flow controllers try to control the flows, they affect the pressure. So, the flow control loops and the pressure control loop can get into a see-saw battle resulting in poor flow control performance.

To effectively control this self-organizing multi-stream liquid flow delivery process, key elements of the process, namely the pressure valve 30 and the flow valves 20, 22, and 24 must act at the same time in a coordinated way. It is important that the actuation and control system be capable of doing so. In other words, the actuation and control become enabling elements for the Self-Organizing process.

FIG. 3 is a process and instrument diagram illustrating a multi-stream flow delivery process control system comprising a Multivariable Self-Organizing Actuation and Control Unit (SOACU) according to an embodiment of this invention. The system comprises a Multivariable Self-Organizing Actuation and Control Unit (SOACU) 48, m flow control valves 30, 32, . . . , 34, m flow sensors 42, 44, . . . , 46, a pressure control valve 38, a flow pump 36, and a pressure transducer (PT) 40. In this case, multivariable means that there are multiple flows as process variables to be controlled.

The SOACU 48 comprises m internal flow controllers and an internal pressure controller. Designed to work as one unit, the SOACU has m flow setpoints SP1, SP2, SPm, m flow process variables PV1, PV2, PVm for Flow 1, Flow 2, . . . , Flow m, respectively, and one pressure process variable PVp. It produces m flow control output signals OP1, OP2, OPm, and one pressure control signal OPp. The control objective is for the SOACU to produce output signals OP1, OP2, OPm, and OPp to manipulate Valve Fl, Valve F2, . . . , Valve Fm, and Valve P, respectively, so that the flow process variables PV1, PV2, PVm track the given trajectory of their corresponding setpoints SP1, SP2, SPm under all operating conditions where there can be large and random flow and pressure disturbances caused by sudden changes in the flow supply and demand.

FIG. 4 is a block diagram illustrating a multi-stream flow delivery process control system comprising a Multivariable Self-Organizing Actuation and Control Unit (SOACU) according to an embodiment of this invention. The system comprises a Multivariable Self-Organizing Actuation and Control Unit (SOACU) 50, m flow valves for controlling m flows: Valve F1 54, Valve F2 55, . . . , Valve Fm 56, a pressure valve 58, and a multi-stream flow and pressure process 52.

The control objective is for the Multivariable Self-Organizing Actuation and Control Unit (SOACU) 50 to produce m flow control outputs OP1, OP2, OPm to manipulate the m flow valves. At the same time, the SOACU produces a pressure control output OPp to manipulate the pressure valve 58 in a coordinated way so that the flow process variables PV1, PV2, PVm track their corresponding setpoints SP1, SP2, SPm under all operating conditions.

FIG. 5 is a block diagram illustrating a multi-stream flow delivery process control system comprising multiple single-loop flow control sub-systems and a pressure control sub-system using Model-Free Adaptive (MFA) controllers to show the composition of the Multivariable Self-Organizing Actuation and Control Unit (SOACU) in FIGS. 3 and 4 according to an embodiment of this invention.

The system comprises m flow control sub-systems that include m flow controllers, where SISO MFA controllers can be used. Flow controller FC1 62 produces output OP1 to manipulate Valve F1 64 to control the flow process 66. Flow controller FC2 68 produces output OP2 to manipulate Valve F2 70 to control the flow process 72. Flow controller FCm 74 produces output OPm to manipulate Valve Fm 76 to control the flow process 78.

From another view point, the system comprises a Self-Organizing Actuation and Control Unit (SOACU) 60, which further comprises m internal flow controllers FIC1 62, FIC2 68, . . . , FICm 74, an internal pressure controller PIC 82, and an Output Feedback Coordinator 80. Designed to work as one unit, the SOACU has m flow setpoints SP1, SP2, SPm, m flow process variables PV1, PV2, PVm for Flow Process 1, Flow Process 2, . . . , Flow Process m, respectively, and one pressure process variable PVp. The SOACU 60 produces m flow control output signals OP1, OP2, OPm, and one pressure control signal OPp. The control objective is for the SOACU to produce output signals OP1, OP2, OPm, and OPp to manipulate Valve Fl, Valve F2, . . . , Valve Fm, and Valve P, respectively, so that the flow process variables PV1, PV2, PVm track the given trajectory of their corresponding setpoints SP1, SP2, SPm under all operating conditions where there can be large and random flow and pressure disturbances caused by sudden changes in the flow supply and demand.

The internal pressure controller PIC 82 has two inputs PVp and PVu, and one output OPp. So, it is a 2-Input-1-Ouput (2×1) controller, where a 2×1 Robust MFA controller is used. Its setpoint SPu can be set using a pre-determined default value such as 40%, which is the mid point of the “linear” range (0%-80%) of the flow valve. This way, the user does not need to enter a setpoint for the internal PIC controller. Please note that in a flow delivery process, each of the flows may need to be cut off so that the control valve may be working at 0% position. The “Fast Close” type of flow control valves should be selected in this case since the valve gain in the lower working range is relatively small. If a “Fast Open” type of the flow control valves is used, the lower working range will have a much higher valve gain which can cause the flow control loops to oscillate, even when valve positioners are used.

The Output Feedback Coordinator 80 receives the flow controller output signals OP1, OP2, OPm as inputs. These are flow valve position feedback signals. The Output Feedback Coordinator 80 produces a signal y(t)=PVu as the primary Process Variable for the 2×1 Robust MFA controller 82.

The SISO MFA controllers that can be used in this embodiment have been described in U.S. Pat. Nos. 6,055,524 and 6,556,980. The 2×1 Robust MFA controller along with its corresponding Output Feedback Coordinator 80 is unique and will be described in FIG. 6.

FIG. 6 is a block diagram illustrating the detailed design of a 2×1 Robust MFA Controller and an Output Feedback Coordinator as part of the Self-Organizing Actuation and Control Unit (SOACU) in FIG. 5 according to an embodiment of this invention. In FIG. 6, the 2×1 Robust MFA Controller 116 comprises a primary MFA Controller 88, an Upper-bound Controller 90, a Lower-bound Controller 92, an Upper-bound Setpoint Setter 94, a Lower-bound Setpoint Setter 96, Signal Adders 98, 100, 102, a Constraint Setter 104, a Feedforward MFA Controller 106, and an Output Combiner 108. The 2×1 MFA Controller 116 generates an output control signal OPp to manipulate the Pressure Valve 110 to control the Pressure Process 112. Since the Upper-bound Controller 90 and Lower-bound Controller 92 provide constraints to the output of the Primary Controller 88, they are also called Constraint Controllers.

In FIG. 6, there is also an Output Feedback Coordinator 114. It receives the flow controller output signals OP1, OP2, OPm as inputs. These are flow valve position feedback signals. The Output Feedback Coordinator produces an output y(t), which is used as the primary Process Variable PVu for the 2×1 Robust MFA controller 116.

Since each of the m flow valves may work at a different position, the Output Feedback Coordinator 114 needs to be designed based on certain criteria or logic to produce an adequate output. As an example, the Output Feedback Coordinator 114 can be designed to take the highest output from the m flow position signals as follows:

y(t)=MAX [OP1, OP2, OPm], (1)

where MAX is a high-selector function. In this case, the highest output from a flow controller output can be considered the worst case scenario as it is the one that may have already been outside the Upper-bound or is approaching the Upper-bound. In this case, the 2×1 MFA controller will regulate the pressure valve to change pressure of the flow lines so that the flow valve that is above the pre-set Upper-bound can move back within the bound. Please understand that this pressure valve movement actually changes the flow rate of the main flow, which should result in a better material balance. The essence of a self-organizing process enabled by its actuation and control system is about keeping the material and energy in balance. This balance is achieved with key elements acting together in a coordinated way at the same time.

As another example, the Output Feedback Coordinator 114 can also be designed to take the average value from the m flow position signals as follows:

y(t)=AVG [OP1, OP2, OPm], (2)

where AVG is an averaging function. In this case, the balance of all the flows is considered important.

In applications where the lowest output from a flow controller is considered the worst case scenario, the Output Feedback Coordinator 114 can be designed to take the lowest value as follows:

y(t)=MIN [OP1, OP2, OPm], (3)

where MIN is a low-selector function. In this case, the flow controller that has the lowest output may have already been outside the Lower-bound or is approaching the Lower-bound.

The signals shown in FIG. 6 are as follows:

r(t)=SPu—Setpoint of the 2×1 Robust MFA controller,

y(t)=PVu—Process Variable 1 for the 2×1 Robust MFA controller,

u(t)—Primary Controller Output,

e(t)—Error between the Setpoint and Process Variable, e(t)=SPu—PVu,

r₁(t)—Upper-bound Controller Setpoint,

r₂(t)—Lower-bound Controller Setpoint,

u₁(t)—Upper-bound Controller Output,

u₂(t)—Lower-bound Controller Output,

u_{c}(t)—The Combined Controller Output,

e₁(t)—Error between r₁(t) and y(t), e₁(t)=r₁(t)—y(t),

e₂(t)—Error between r₂(t) and y(t), e₂(t)=r₂(t)—y(t),

Pd=PVp—Differential Pressure=Process Variable 2 for the 2×1 Robust MFA controller,

u_{f}(t)—Feedforward MFA Controller Output, and

OPp—2×1 Robust MFA Controller Output.

As shown in FIG. 6, controllers 90 and 92 are used as the Upper-bound and Lower-bound constraint controllers, respectively. They can provide smart upper and lower boundaries for Process Variable y(t). The Constraint Setter 104 forces u(t) to be bounded by the controller outputs u₁(t) and u₂(t) under certain conditions.

To setup a Robust MFA control system, the user is allowed to enter an Upper-bound (UB) and a Lower-bound (LB) for the Process Variable (PV). These bounds are typically the marginal values that the Process Variable should not go beyond.

It is important to understand that a process variable (PV) is unlike a controller output (OP). A hard limit or constraint can be set for OP since it is a signal produced by a controller. PV is the measured variable for the process output. Its value is a signal obtained from a measurement device such as a sensor. Therefore, trying to limit the PV within a bound can only be done by changing the controller OP to manipulate the process input, which will affect the process output, the PV. To summarize, the PV Upper and Lower bounds are very different than the OP constraints.

The PV Upper and Lower bounds for a Robust MFA controller can be set based on several options as described in the U.S. Pat. No. 6,684,112. In this 2×1 Robust MFA controller case, we can set the bounds relating as follows:

The Upper-bound is set based on an actual value:

r₁(t)=UB, (4)

where UB>r(t) is the Upper-bound with the same unit of the Process Variable, and r₁(t) is the Setpoint of the UB Controller.

The Upper-bound is set based on an actual value:

r₂(t)=LB, (5)

where LB<r(t) is the Lower-bound with the same unit of the Process Variable, and r₂(t) is the Setpoint of the LB Controller.

For instance, we can set UB=80% and LB=0% for the flow delivery application, where “Normally-Closed” valves are used. As a fail-safe feature, a normally-closed valve cuts off the flow when the valve loses power.

The Constraint Setter 104 is a limit function f(.) that combines the controller output signals based on the following logic:

u_{c}(t)=u₁(t), if u(t)>u₁(t) (6)

u_{c}(t)=u(t), if u₂(t)≦u(t)≦u₁(t) (7)

u_{c}(t)=u₂(t), if u(t)<u₂(t) (8)

where u₁(t) is the output of Upper-bound Controller 90, u₂(t) is the output of Lower-bound Controller 92, u(t) is the output of Primary Controller 88, and u_{c}(t) is the output of the limit function f_{c}(.).

SISO MFA controllers can be used for the Primary Controller 88 and the Constraint Controllers 90 and 92. The SISO MFA controllers that can be used in this embodiment have been described in U.S. Pat. Nos. 6,055,524 and 6,556,980. The MFA controller parameters have been described in these patents, which include:

K_{c}—MFA Controller Gain, and

T_{c}—MFA Controller Time Constant.

If the Primary Controller 88 is set with K_{c} and T_{c}, the Constraint Controllers 90 and 92 can be set based on, but not limited to, the following formula:

K_{c1}=α₁K_{c} (9)

T_{c1}=β₁T_{c} (10)

K_{c2}=α₂K_{c} (11)

T_{c2}=β₂T_{c} (12)

where K_{c1}, K_{c2}, T_{c1}, and T_{c2}, are the MFA Controller Gain and Time Constant for the Upper-bound Controller and Lower-bound Controllers, respectively; and α₁, α₂, β₁, and β₂ are positive coefficients that can be set with pre-determined default values or re-configured by the user. For instance, we can let α₁=α₂=5, and β₁=β₂=0.5. That means, the Constraint Controllers will have a larger gain and a smaller time constant so that they will react much faster compared to the Primary Controller. The objectives of the Constraint Controllers are to limit the PV from going out of pre-determined upper and lower bounds.

As shown in FIG. 6, the 2×1 Robust MFA Controller 116 comprises another important component, the Feedforward MFA Controller 106. Feedforward control, as the name suggests, is a control scheme to take advantage of forward signals. If a process has a significant potential disturbance and the disturbance can be measured, we can use a feedforward controller to reduce the effect of the disturbance to the control system before the feedback control action takes place. In this case, the differential pressure Pd, which is the Process Variable PVp of the pressure process is used as the feedforward signal for the Feedforward MFA controller 106.

The Feedforward MFA controllers that can be used in this embodiment have been described in U.S. Pat. Nos. 6,556,980, 6,684,115, and 7,016,743.

The Output Combiner 108 is a function fₚ( )that combines the controller output signal u_{c}(t) with the Feedforward MFA controller output signal u_{f}(t). It can be designed in different ways. For instance, the output signals can be combined based on the following formula:

OPp=u_{c}(t)+Δu_{f}(t), (13)

where u_{c}(t) is in the range of [0, 100], Δu_{f}(t) is the delta value of u_{f}(t), which is in the range of [−50, 50], and OPp is in the range of [0, 100].

FIG. 7 is a block diagram illustrating a multi-stream flow delivery process control system comprising multiple single-loop flow control sub-systems and a pressure control sub-system using traditional controllers such as PID controllers to show the composition of a Multivariable Self-Organizing Actuation and Control Unit (SOACU) according to an embodiment of this invention.

The system comprises m flow control sub-systems that include m flow controllers. Flow controller FC1 122 produces output OP1 to manipulate Valve F1 124 to control the flow process 126. Flow controller FC2 128 produces output OP2 to manipulate Valve F2 130 to control the flow process 132. Flow controller FCm 134 produces output OPm to manipulate Valve Fm 136 to control the flow process 138. The SISO controllers that can be used in this embodiment include traditional SISO controllers such as PID (Proportional-Integral-Derivative) controllers.

From a different view point, the system comprises a Multivariable Self-Organizing Actuation and Control Unit (SOACU) 120, which further comprises m internal flow controllers FIC1 122, FIC2 128, . . . , FICm 134, an internal pressure controller PIC 142, and an Output Feedback Coordinator 140. Designed to work as one unit, the SOACU has m flow setpoints SP1, SP2, SPm, m flow process variables PV1, PV2, PVm for Flow Process 1, Flow Process 2, . . . , Flow Process m, respectively, and one pressure process variable PVp. The SOACU 120 produces m flow control output signals OP1, OP2, OPm, and one pressure control signal OPp. The control objective is for the SOACU to produce output signals OP1, OP2, OPm, and OPp to manipulate Valve F1, Valve F2, . . . , Valve Fm, and Valve P, respectively, so that the flow process variables PV1, PV2, PVm track the given trajectory of their corresponding setpoints SP1, SP2, SPm under operating conditions where there can be large and random flow and pressure disturbances caused by sudden changes in the flow supply and demand.

The internal pressure controller PIC 142 has two inputs PVp and PVu, and one output OPp. So, it is a 2-Input-1-Ouput (2×1) controller. Its setpoint SPu can be set using a pre-determined default value such as 40%, which is the mid point of the “linear” range (0%-80%) of the flow valve.

The Output Feedback Coordinator 140 receives the flow controller output signals OP1, OP2, OPm as inputs. These are flow valve position feedback signals. The Output Feedback Coordinator 140 produces a signal y(t)=PVu as the primary Process Variable for the 2×1 Controller PIC 142. The Output Feedback Coordinator can be designed based on formulas (1) to (3).

This is a general case where a Multivariable Self-Organizing Actuation and Control Unit (SOACU) can be designed using traditional SISO controllers such as PID (Proportional-Integral-Derivative) controllers. The 2×1 Controller that can be used in this embodiment can be designed using the Robust MFA control technology described in the U.S. pat. No. 6,684,112.

To summarize, the components and key variables comprised in the multi-stream flow delivery control system using the SOACU approach in FIGS. 5, 6, and 7 are listed in Table 2.

TABLE 2

| Symbol | SOACU | Note |
|---|---|---|
| FIC1 | Internal Flow Controller 1 | SISO MFA or PID Controller |
| FIC2 | Internal Flow Controller 2 | SISO MFA or PID Controller |
| FICm | Internal Flow Controller m | SISO MFA or PID Controller |
| SP1 | Flow Control Setpoint 1 | |
| SP2 | Flow Control Setpoint 2 | |
| SPm | Flow Control Setpoint m | |
| PV1 | Flow Process Variable 1 | |
| PV2 | Flow Process Variable 2 | |
| PVm | Flow Process Variable m | |
| OP1 | Flow Control Output 1 | |
| OP2 | Flow Control Output 2 | |
| OPm | Flow Control Output m | |
| PIC | Internal Pressure Controller | 2 x 1 Robust MFA Controller |
| SPu | Internal PIC Setpoint | Set to a Pre-determined Value |
| PVp | Pressure Process Variable | From the Pressure Transducer |
| PVu | Position Feedback | Produced by the Output |
| | | Feedback Coordinator |
| OPp | Output to Pressure Valve | |
| Pa | Head Pressure. | |
| Pb | Back Pressure. | |
| Pd | Differential Pressure. | |

A good application for a Self-Organizing Multi-Stream Flow Delivery Process is in the medical device field. For instance, endoscope and Colonoscopy equipment require consistent control in fluid flows, temperature, and pressure during procedures and when cleaning and disinfecting. Commercial scale endoscope equipment may have 4, 8, and 16 channels, each of which needs to deliver liquid flow at proper flow rate and temperature. When the supply and demand of the fluid flows vary, disturbances to the flow and pressure can cause undesirable or even unsafe results to the patients.

The Self-Organizing Multi-Stream Flow Delivery Process and Enabling Self-Organizing Actuation and Control offer a unique and powerful solution for flow delivery in a broad range of applications. Large systems such as oil pipelines and industrial processing plants to micro-fluid delivery processes in new generation micro-scale devices useful in the field of bio-tech, medical equipment, robotics, semiconductors, and aviation can all benefit from this invention.

1. A self-organizing multi-stream flow delivery process control system, comprising:
a) a multivariable self-organizing actuation and control unit (SOACU); and
b) a multi-stream liquid flow delivery process, including:
i) a main liquid flow stream,
ii) a flow pump on the main liquid flow stream,
iii) a pressure valve on the main liquid flow stream,
iv) a pressure transducer that can measure the differential pressure of the pressure valve,
v) a plurality of sub liquid flow streams, and
vi) a flow valve on each of the sub liquid flow streams.

2. The self-organizing multi-stream flow delivery process control system of claim 1, in which the multivariable self-organizing actuation and control unit (SOACU) comprises:
a) a pressure controller;
b) a pressure process variable;
c) a pressure control output to manipulate the pressure valve;
d) a flow controller for each sub liquid flow stream;
e) a flow process variable for each sub liquid flow stream;
f) a flow control output for each sub liquid flow stream to manipulate its corresponding flow valve; and
g) a user selectable setpoint for each sub liquid flow stream.

3. The self-organizing multi-stream flow delivery process control system of claim 2, in which the multivariable self-organizing actuation and control unit (SOACU) receives a differential pressure measurement signal for the main liquid flow stream and a flow measurement signal for each of the sub liquid flow streams.

4. The self-organizing multi-stream flow delivery process control system of claim 2, in which the multivariable self-organizing actuation and control unit (SOACU) manipulates the pressure valve and flow valves in a coordinated way.

5. The self-organizing multi-stream flow delivery process control system of claim 2, in which the flow process variables track a given trajectory of their corresponding user selectable setpoints.

6. A multivariable self-organizing actuation and control unit (SOACU), comprising:
a) a pressure controller;
b) a primary process variable and a secondary process variable for the pressure controller;
c) an internal pressure setpoint;
d) a pressure control output;
e) a plurality of flow controllers;
f) a plurality of user selectable flow control setpoints;
g) a plurality of flow process variables;
h) a plurality of flow control outputs; and
i) an output feedback coordinator.

7. The multivariable self-organizing actuation and control unit (SOACU) of claim 6, in which the pressure control output manipulates a pressure control valve, and the flow control outputs manipulate corresponding flow control valves, respectively, in a coordinated way.

8. The multivariable self-organizing actuation and control unit (SOACU) of claim 6, in which the user selectable flow control setpoints correspond to desirable liquid flow streams of a multi-stream liquid flow delivery process.

9. The multivariable self-organizing actuation and control unit (SOACU) of claim 6, in which the flow controllers are single-input-single-output (SISO) controllers.

10. The multivariable self-organizing actuation and control unit (SOACU) of claim 6, in which the flow controllers are single-input-single-output (SISO) Model-Free Adaptive (MFA) controllers.

11. The multivariable self-organizing actuation and control unit (SOACU) of claim 6, in which the pressure controller is a multi-input-single-output (MISO) Model-Free Adaptive (MFA) controller.

12. The multivariable self-organizing actuation and control unit (SOACU) of claim 11, in which the multi-input-single-output (MISO) Model-Free Adaptive (MFA) controller is a 2-Input-1-Output (2×1) Robust MFA controller, comprising:
a) a primary controller;
b) an upper bound controller;
c) a lower bound controller;
d) an upper bound setpoint setter;
e) a lower bound setpoint setter;
f) a primary process variable and a secondary process variable;
g) an internal setpoint;
h) a plurality of signal adders;
i) a constraint setter;
j) a feedforward MFA controller; and
k) an output combiner that produces a control output.

13. The multivariable self-organizing actuation and control unit (SOACU) of claim 12, in which the constraint setter is a limit function f_{c}(.) that combines control outputs of the 2×1 robust MFA controller substantially in the following form:
u_{c}(t)=u₁(t), if u(t)>u₁(t)
u_{c}(t)=u(t), if u₂(t)≦u(t)≦u₁(t)
u_{c}(t)=u₂(t), if u(t)<u₂(t)
where u₁(t) is an output of the upper-bound controller, u₂(t) is an output of the lower-bound controller, u(t) is an output of the primary controller, and u_{c}(t) is an output of the limit function f_{c}(.).

14. The multivariable self-organizing actuation and control unit (SOACU) of claim 6, in which the output feedback coordinator receives the outputs from the flow controllers as inputs and produces a signal substantially in one or more of the following forms:
y(t)=MAX [OP1, OP2, OPm],
y(t)=AVG [OP1, OP2, OPm],
y(t)=MIN [OP1, OP2, OPm],
where MAX is a high-selector function, AVG is a average function, MIN is a low-selector function, and OP1, OP2, . . . , OPm are the outputs from the flow controllers.

15. The multivariable self-organizing actuation and control unit (SOACU) of claim 6, in which the primary process variable for the pressure controller is the output of the output feedback coordinator.

16. A method of controlling a multi-stream flow delivery process having a main liquid flow stream, a flow pump on the main liquid flow stream, a plurality of sub liquid flow streams, and a flow valve on each of the sub liquid flow streams, comprising:
a) employing a pressure valve on the main liquid flow stream;
b) measuring a differential pressure of the pressure valve using a pressure transducer;
c) measuring a flow process variable for each of the sub liquid flow streams;
d) selecting a setpoint representing a desired value for the measured flow process variable for each of the sub liquid flow streams;
e) calculating control outputs based on the selected setpoints and measured differential pressure and flow process variables; and
f) producing control outputs to manipulate the pressure valve and the flow valves in a coordinate way so that each measured flow process variable tracks a given trajectory of a corresponding user selectable setpoint.

17. The method of controlling a multi-stream flow delivery process of claim 16, in which a multivariable self-organizing actuation and control unit (SOACU) is utilized.

18. The method of controlling a multi-stream flow delivery process of claim 16, in which Model-Free Adaptive (MFA) controllers are utilized.
